(19) United States
(12) Patent Application Publication
(10) Pub. No.: US 2010/0251888 A1
(43) Pub. Date: Oct. 7, 2010

(54) Oxygen-Ion Conducting Membrane Structure

(76) Inventors: Curtis Robert Fekety, Corning, NY (US); Yunfeng Gu, Painted Post, NY (US); Lin He, Corning, NY (US); Youchun Shi, Corning, NY (US); Zhen Song, Painted Post, NY (US)

Correspondence Address: CORNING INCORPORATED, SP-TI-3-1, CORNING, NY, 14831, US

(21) Appl. No.: 12/742,570

(22) PCT Filed: Nov. 14, 2008
(86) PCT No.: PCT/US08/12798

§ 371 Date: May 12, 2010

Related U.S. Application Data
(60) Provisional application No. 61/003,812, filed on Nov. 20, 2007.

(51) Int. Cl. B01D 71/02; B01D 53/22; C01B 13/02; C04B 35/01

(52) U.S. Cl. 95/54; 96/11; 96/4

(57) ABSTRACT

An oxygen-ion conducting membrane structure comprising a monolithic inorganic porous support, optionally one or more porous inorganic intermediate layers, and an oxygen-ion conducting ceramic membrane. The oxygen-ion conducting hybrid membrane is useful for gas separation applications, for example O₂ separation.

### CROSS-REFERENCE TO RELATED APPLICATIONS

This application claims the benefit of priority to U.S. provisional application No. 61/003,812, filed on Nov. 20, 2007, which is incorporated by reference herein.

### FIELD

The present invention relates to oxygen-ion conducting membrane structures useful for molecular level gas separations and methods for making and using the same.

### BACKGROUND

Significant efforts have been made to develop highly efficient power technologies with minimal pollutant discharge to the environment. Ceramic membranes, such as oxygen permeable membranes, could play an important role in developing low emission and high energy efficient technologies.

Driven by clean coal technologies and CO₂ regulations, oxygen membrane technology has potential for wide applications. For instance, such membranes could be useful in the conversion of coal to liquid fuel and in the conversion of natural gas to liquid fuels and chemicals. Oxygen permeable membranes can be adapted to provide a cost-effective alternative for accomplishing the first half of the transition from natural gas to syngas to hydrogen fuel. This process could result in an economically efficient two-step technique to provide pure hydrogen for transportation. Oxygen membrane technology may also be used to provide oxygen or oxygen-rich combustion for high efficiency and lower pollution, especially for low NOₓ burning.

Today, cryogenic technology is the dominant method for accomplishing the separation of O₂. However, the cryogenic method requires large investment in equipment with very high power consumption. Another O₂ separation approach is through the use of polymer O₂ membranes, but that appears only feasible at low temperature (about 40° C.) and is not suitable for applications mentioned above. Ceramic oxygen membranes, however, would be an appropriate choice for high temperature (700-1,000° C.) applications. They could significantly reduce capital cost and energy cost for O₂ generation as compared with cryogenics.

Conventional inorganic membranes, however, frequently offer a relatively low surface area packing density because of the inorganic membrane's tubular or planar disk forms, as illustrated in FIGS. 1A and 1B. In FIGS. 1A and 1B, arrow 102 represents a gas mixture that is to be separated; arrow 104 represents a permeate stream; and arrow 106 represents a retentate stream.

In view of the forgoing, there is a need for additional materials and methods that can be used for molecular level gas separations, and the present invention is directed, at least in part, to addressing this need.

### SUMMARY

One embodiment of the present invention relates to a hybrid membrane structure comprising:
a monolithic inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
an oxygen-ion conducting ceramic membrane; wherein, when the hybrid membrane structure does not comprise the one or more porous inorganic intermediate layers, the oxygen-ion conducting ceramic membrane coats the inner channel surfaces of the inorganic porous support; and wherein, when the hybrid membrane structure comprises the one or more porous inorganic intermediate layers, the oxygen-ion conducting ceramic membrane coats the surface of the one or more porous intermediate layers.

The present invention also relates to a method for making a hybrid membrane structure, which comprises:
providing a monolithic inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support; and
applying an oxygen-ion conducting ceramic membrane; wherein, when the one or more porous inorganic intermediate layers have not been applied to the inorganic porous support's inner channel surfaces, the oxygen-ion conducting ceramic membrane is applied to the inner channel surfaces of the inorganic porous support; and wherein, when the one or more porous inorganic intermediate layers have been applied to the inorganic porous support's inner channel surfaces, the oxygen-ion conducting ceramic membrane is applied to the surface of the one or more porous intermediate layers.

Alternatively, another embodiment of the invention is a monolithic inorganic porous membrane comprising a first end, a second end, and a plurality of inner channels having surfaces defined by porous walls and extending through the support from the first end to the second end, wherein the monolithic inorganic porous membrane comprises a mixed-conductive material. Such a monolith serves as a membrane, allowing oxygen permeation through walls of its channels.

The membrane structures could be used to solve significant separation problems in processing industries, such as O₂ separation.

These and additional features and embodiments of the present invention will be more fully illustrated and discussed in the following drawings and detailed description.

### BRIEF DESCRIPTION OF THE DRAWINGS

FIGS. 1A and 1B are schematic representations of conventional inorganic gas separation membrane designs and the flow of gases therein. FIG. 1A shows a perspective view of a tubular membrane. FIG. 1B shows a cross-sectional view of a planar disk membrane.

FIG. 2 is a representation of a hybrid membrane structure according to one embodiment the present invention.

FIG. 3 is a longitudinal cross-sectional representation of a hybrid membrane structure according to the present invention taken through plane A of FIG. 2.

FIG. 4 is a schematic representation of a hybrid membrane structure according to the present invention showing its use in a gas separation application.

FIGS. 5A and 5B are SEM images of the cross-sectional views of monolithic inorganic porous supports having two porous inorganic intermediate layers (5A) and three porous inorganic intermediate layers (5B), respectively.

FIG. 6 is an X-ray diffraction pattern of perovskite powders prepared by a flame spray pyrolysis method.

FIG. 7 is a perspective view of a honeycomb membrane comprising plugged channels in a checkerboard pattern.

FIG. 8 illustrates a portion of a honeycomb membrane in a gas separation method according to an embodiment of the invention.

FIG. 9 illustrates an example gas collection system according to an embodiment of the invention.

FIGS. 10A and 10B are cross-sectional views of an example gas collection system shown through plane B of FIG. 9.

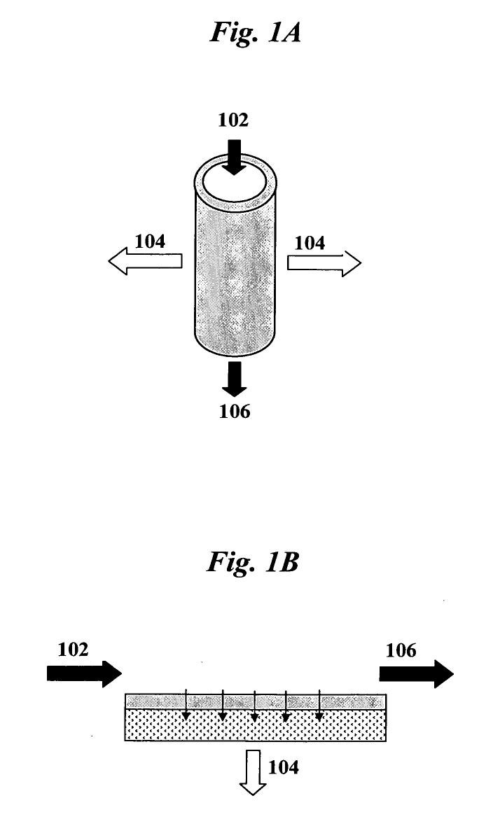

The embodiments set forth in the figures are illustrative in nature and not intended to be limiting of the invention defined by the claims. Individual features of the drawings and the invention will be more fully discussed in the following detailed description.

### DETAILED DESCRIPTION

One aspect of the present invention relates to a hybrid membrane structure that comprises:
a monolithic inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
an oxygen-ion conducting ceramic membrane; wherein, when the hybrid membrane structure does not comprise the one or more porous inorganic intermediate layers, the oxygen-ion conducting ceramic membrane coats the inner channel surfaces of the inorganic porous support; and wherein, when the hybrid membrane structure comprises the one or more porous inorganic intermediate layers, the oxygen-ion conducting ceramic membrane coats the surface of the one or more porous intermediate layers.

Suitable inorganic porous support materials include ceramics, glass ceramics, glasses, carbon, metals, clays, and combinations thereof. Examples of these and other materials from which the inorganic porous support can be made or which can be included in the inorganic porous support are, illustratively: metal oxide, alumina (e.g., alpha-aluminas, delta-aluminas, gamma-aluminas, or combinations thereof), cordierite, mullite, aluminum titanate, titania, zeolite, metal (e.g., stainless steel), ceria, magnesia, talc, zirconia, zircon, zirconates, zirconia-spinel, spinel, silicates, borides, alumino-silicates, porcelain, lithium alumino-silicates, feldspar, magnesium alumino-silicates, fused silica, carbides, nitrides, silicon carbides, and silicon nitrides.

In certain embodiments, the inorganic porous support is primarily made from or otherwise comprises alumina (e.g., alpha-alumina, delta-alumina, gamma-alumina, or combinations thereof), cordierite, mullite, aluminum titanate, titania, zirconia, zeolite, metal (e.g., stainless steel), silicon carbide, silicon nitride, ceria, or combinations thereof. In other embodiments, the inorganic porous support itself may comprise a porous oxygen-ion conducting ceramic material.

In one embodiment, the inorganic porous support is a glass. In another embodiment, the inorganic porous support is a glass-ceramic. In another embodiment, the inorganic porous support is a ceramic. In another embodiment, the inorganic porous support is a metal. In yet another embodiment, the inorganic porous support is carbon, for example a carbon support derived by carbonizing a resin, for example, by carbonizing a cured resin.

In certain embodiments, the inorganic porous support is in the form of a honeycomb monolith. Honeycomb monoliths can be manufactured, for example, by extruding a mixed batch material through a die to form a green body, and sintering the green body with the application of heat utilizing methods known in the art. In certain embodiments, the inorganic porous support is in the form of ceramic monolith. In certain embodiments, the monolith, for example a ceramic monolith, comprises a plurality of parallel inner channels.

The inorganic porous support can have a high geometric surface area, such as a geometric surface area of greater than 500 m²/m³, greater than 750 m²/m³, and/or greater than 1000 m²/m³.

As noted above, the monolithic inorganic porous support includes a plurality of inner channels having surfaces defined by porous walls. The number, spacing, and arrangement of the inner channels can be selected in view of the potential application of the hybrid membrane structure. For example the number of channels can range from 2 to 1000 or more, such as from 5 to 500, from 5 to 50, from 5 to 40, from 5 to 30, from 10 to 50, from 10 to 40, from 10 to 30, etc; and these channels can be of substantially the same cross sectional shape (e.g., circular, oval, square, hexagonal, triangular etc.) or not. The channels can be substantially uniformly dispersed in the inorganic porous support's cross section or not (e.g., as in the case where the channels are arranged such that they are closer to the outer edge of the inorganic porous support than to the center). The channels can also be arranged in a pattern (e.g., rows and columns, offset rows and columns, in concentric circles about the inorganic porous support's center, etc.).

In certain embodiments, the inner channels of the inorganic porous support have a hydraulic inside diameter of from 0.5 millimeters to 3 millimeters, such as in cases where the inner channels of the inorganic porous support have a hydraulic inside diameter of 1±0.5 millimeter, 2±0.5 millimeter, from 2.5 millimeters to 3 millimeters, and/or from 0.8 millimeters to 1.5 millimeters. In certain embodiments, the inner channels of the inorganic porous support have a hydraulic inside diameter of 3 millimeters or less, for example less than 3 millimeters. For clarity, note that “diameter” as used in this context is meant to refer to the inner channel's cross sectional dimension and, in the case where the inner channel's cross section is non-circular, is meant to refer to the diameter of a hypothetical circle having the same cross sectional area as that of the non-circular inner channel.

In certain embodiments, the porous walls which define the inner channels' surfaces have a median pore size of 25 microns or less. In certain embodiments, the porous walls which define the inner channels' surfaces have a median pore size of from 5 nanometers to 25 microns, such as in cases where the porous walls which define the inner channels' surfaces have a median pore size of 10±5 nanometers, 20±5 nanometers, 30±5 nanometers, 40±5 nanometers, 50±5 nanometers, 60±5 nanometers, 70±5 nanometers, 80±5 nanometers, 90±5 nanometers, 100±5 nanometers, 100±50 nanometers, 200±50 nanometers, 300±50 nanometers, 400±50 nanometers, 500±50 nanometers, 600±50 nanometers, 700±50 nanometers, 800±50 nanometers, 900±50 nanometers, 1000±50 nanometers, 1±0.5 microns, and/or 2±0.5 microns. In other embodiments, the inner channel surfaces have a median pore size from 5 microns to 15 microns.

In certain embodiments, the porous walls which define the inner channels' surfaces have a median pore size of 1 micron or less. In certain embodiments, the porous walls which define the inner channels' surfaces have a median pore size of 500 nanometers or less, such as in cases where the porous walls which define the inner channels' surfaces have a median pore size of from 5 nanometers to 500 nanometers, from 5 nanometers to 400 nanometers, from 5 nanometers to 300 nanometers, from 5 nanometers to 400 nanometers, from 5 nanometers to 300 nanometers, from 5 nanometers to 400 nanometers, from 5 nanometers to 200 nanometers, from 5 nanometers to 100 nanometers, from 5 nanometers to 50 nanometers, etc. For clarity, note that “size” as used in this context is meant to refer to a pore's cross sectional diameter and, in the case where the pore's cross section is non-circular, is meant to refer to the diameter of a hypothetical circle having the same cross sectional area as that of the non-circular pore.

In certain embodiments, the inorganic porous support has a porosity of from 20 percent to 80 percent, such as a porosity of from 30 percent to 60 percent, from 50 percent to 60 percent, or from 35 percent to 50 percent. When a metal, such as stainless steel, is used as the inorganic porous support, porosity in the stainless steel support can be effected, for example, using engineered pores or channels made by three-dimensional printing, by high energy particle tunneling, and/or by particle sintering using a pore former to adjust the porosity and pore size.

To allow for more intimate contact between a fluid stream flowing through the support and the coated support itself, for example when used in a separation application, it is desired in certain embodiments that at least some of the channels are plugged at one end of the support, for example on the inlet end of the support. In certain embodiments, it is desired that the plugged and/or unplugged channels form a checkerboard pattern with each other. It will be appreciated that individual inorganic porous supports can be stacked or housed in various manners to form larger inorganic porous supports or assemblies having various sizes, service durations, and the like to meet the needs of differing use conditions.

As noted above, the hybrid membrane structure can optionally comprise one or more porous inorganic intermediate layers coating the inner channel surfaces of the inorganic porous support. In certain embodiments, the hybrid membrane structure does not comprise the one or more porous inorganic intermediate layers. In this instance, the oxygen-ion conducting ceramic membrane coats the inner channel surfaces of the inorganic porous support. In one embodiment of this aspect of the invention, the inorganic porous support comprises a median pore size of 1 micron or less.

In other embodiments, the hybrid membrane structure does include the one or more porous inorganic intermediate layers. In this instance, the oxygen-ion conducting ceramic membrane coats the surface of the one or more porous intermediate layers. In one embodiment of this aspect of the invention, the inorganic porous support comprises a median pore size of 5 microns to 15 microns.

In those cases where the hybrid membrane structure does comprise the one or more porous inorganic intermediate layers, and the oxygen-ion conducting ceramic membrane coats the surface of the one or more porous intermediate layers, it will be appreciated that the “surface of the one or more porous intermediate layers” refers to the outer surface of the intermediate layer (i.e., the surface that is exposed to the channel) or, in the case where there is more than one porous intermediate layer, to the outer surface of the outermost intermediate layer (i.e., the intermediate layer most distant from the inner channel surfaces of the inorganic porous support). In particular, the phrase “the oxygen-ion conducting ceramic membrane coats the surface of the one or more porous intermediate layers” is not meant to be construed as requiring that the oxygen-ion conducting ceramic membrane coat every porous intermediate layer or every side of every porous intermediate layer.

Whether or not to employ the one or more porous inorganic intermediate layers can depend on a variety of factors, such as the nature of the inorganic porous support; the median diameter of the inorganic porous support's inner channels; the use to which the hybrid membrane structure is to be put and the conditions (e.g., gas flow rates, gas pressures, etc.) under which it will be employed; the roughness or smoothness of the inner channels' surfaces; the median pore size of the porous walls which define the inner channels' surfaces; and the like. Furthermore, as explained in greater detail below, an intermediately layer may be used to prevent or minimize chemical reactions between the oxygen-ion conducting ceramic membrane and the underlying support or an underlying intermediate layer.

By way of illustration, in certain embodiments, the porous walls of the inorganic porous support comprise a median pore size that is sufficiently small so that, when the oxygen-ion conducting ceramic membrane is coated directly on the inner channels' surfaces, the resulting coating is smooth and thin. Examples of median pore sizes that are thought to be sufficiently small so as not to significantly benefit (in terms of smoothness of the oxygen-ion conducting ceramic membrane coating) from the use of the porous inorganic intermediate layer(s) (for at least some applications) are those that are less than about 100 nanometers. Even less benefit is attained when the median pore size is less than about 80 nanometers; still less benefit is attained when the median pore size is less than about 50 nanometers (e.g., in the 5 nanometer to 50 nanometer range).

By way of further illustration, in certain embodiments, the porous walls of the inorganic porous support comprise a median pore size that is sufficiently large so that, when the oxygen-ion conducting ceramic membrane is coated directly on the inner channels' surfaces, the resulting coating may be rough. In such cases, it may be advantageous to use the porous inorganic intermediate layer(s). Examples of median pore sizes that are thought to be sufficiently large so as to significantly benefit (in terms of smoothness of the oxygen-ion conducting ceramic membrane coating) from the use of the porous inorganic intermediate layer(s) (for at least some applications) are those that are more than about 100 nanometers. Even greater benefit is attained when the median pore size is more than about 200 nanometers; still greater benefit is attained when the median pore size is more than about 300 nanometers (e.g., in the 300 nanometer to 50 micron range).

Illustratively, in certain embodiments, the porous walls of the inorganic porous support have a median pore size of from 5 nanometers to 100 nanometers (e.g., from 5 nanometers to 50 nanometers), the hybrid membrane structure does not include the one or more porous inorganic intermediate layers, and the oxygen-ion conducting ceramic membrane coats the inner channel surfaces of the inorganic porous support. In other embodiments, the porous walls of the inorganic porous support have a median pore size of from 50 nanometers to 25 microns (e.g., from 100 nanometers to 15 microns or from 5 microns to 15 microns), the hybrid membrane structure comprises the one or more porous inorganic intermediate layers, and the oxygen-ion conducting ceramic membrane coats the surface of the one or more porous intermediate layers.

As noted above, the one or more porous inorganic intermediate layers can be used to increase the smoothness of the surface onto which the oxygen-ion conducting ceramic membrane is coated, for example, to improve flow of a gas that may pass through the channels; to improve uniformity of the oxygen-ion conducting ceramic membrane coating; to decrease the number and/or size of any gaps, pinholes, or other breaks in the oxygen-ion conducting ceramic membrane coating; to decrease the thickness of the oxygen-ion conducting ceramic membrane coating needed to achieve an oxygen-ion conducting ceramic membrane coating having an acceptably complete coverage (e.g. no or an acceptably small number of gaps, pinholes, or other breaks). Additionally or alternatively, the one or more porous inorganic intermediate layers can be used to decrease the effective diameter of the inorganic porous support's inner channels. Still additionally or alternatively, the one or more porous inorganic intermediate layers can be used to alter the chemical, physical, or other properties of the surface onto which the oxygen-ion conducting ceramic membrane is coated.

Examples of materials from which the one or more porous inorganic intermediate layers can be made include metal oxides, ceramics, glasses, glass ceramics, carbon, and combinations thereof. Other examples of materials from which the one or more porous inorganic intermediate layers can be made include cordierite, mullite, aluminum titanate, zeolite, silica carbide, and ceria. In certain embodiments, the one or more porous inorganic intermediate layers are made from or otherwise include alumina (e.g., alpha-alumina, delta-alumina, gamma-alumina, or combinations thereof), titania, zirconia, silica, or combinations thereof.

In certain embodiments, the median pore size of each of the one or more porous inorganic intermediate layers is smaller than the median pore size of the inorganic porous support's porous walls. By way of illustration, the one or more porous intermediate layers can comprise a median pore size of from 20 nanometers to 1 micron, such as 5 nanometers to 100 nanometers, such as from 5 nanometers to 50 nanometers, from 5 nanometers to 40 nanometers, from 5 nanometers to 30 nanometers, 10±5 nanometers, 20±5 nanometers, 30±5 nanometers, 40±5 nanometers, 50±5 nanometers, 60±5 nanometers, 70±5 nanometers, 80±5 nanometers, and/or 90±5 nanometers. Where two or more porous intermediate layers are present, each of the two or more porous intermediate layers can have the same median pore size or some or all of them can have different median pore sizes.

In certain embodiments, the hybrid membrane structure includes two or more porous intermediate layers, and the median pore size of the porous intermediate layer which contacts the inorganic porous support is greater than the median pore size of the porous intermediate layer which contacts the oxygen-ion conducting ceramic membrane. Illustratively, in cases where the inorganic porous support has a median pore size larger than 300 nm (e.g., larger than 500 nm, larger than 1 micron, larger than 2 microns, larger than 3 microns, etc.) the hybrid membrane structure can include two porous intermediate layers: the first layer (i.e., the one that is in contact with the inorganic porous support) having a median pore size that is smaller than the inorganic porous support's median pore size (e.g., having a median pore size of from 20 nm to 200 nm, for example from 100 nm to 200 nm) and another intermediate layer (i.e., the one that is in contact with the oxygen-ion conducting ceramic membrane) having a median pore size that is smaller than the first intermediate layer's median pore size (e.g., having a median pore size of from 5 nm to 50 nm). Such arrangements can be used to provide a smooth surface onto which the oxygen-ion conducting ceramic membrane is coated without unacceptably decreasing permeability from the inner channels, through the pores of the first intermediate layer, through the larger pores of the second intermediate layer, through the still larger pores of the inorganic porous support, and to the outside of the inorganic porous support.

The hybrid membrane structure may also comprise, for example, three or more intermediate layers. As above, the invention includes an embodiment wherein the median pore sizes of the intermediate layers decreases with each addition of an intermediate layer in the direction of the oxygen-ion conducting ceramic membrane.

In some embodiments, the membrane structure includes an intermediate layer that is chemically inert to the oxygen-ion conducting ceramic membrane material. Such an intermediate layer may serve to minimize or eliminate any reactions between the oxygen-ion conducting ceramic membrane and the inorganic porous support, for example an inorganic porous support comprising alumina. Such an intermediate layer may also be placed between the oxygen-ion conducting ceramic membrane and an underlying intermediate layer, for example an underlying intermediate layer comprising alumina

Example intermediate layers that are chemically inert to the oxygen-ion conducting ceramic membrane material include zirconia, yttrium-stabilized zirconia, or a combination thereof. Thus, in one embodiment, the membrane structure comprises a zirconia or yttrium-stabilized zirconia intermediate layer adjacent to the oxygen-ion conducting ceramic membrane. Such an intermediate layer may be the only intermediate layer between the support and oxygen-ion conducting ceramic membrane, or may be a second or subsequent intermediate layer.

In those cases where the hybrid membrane structure comprises the one or more porous intermediate layers, the one or more porous intermediate layers can have a combined thickness of, for example, from 20 nanometers to 100 microns, such as from 1 micron to 100 microns, such as from 20 nanometers to 100 microns, such as from 2 microns to 80 microns, from 5 microns to 60 microns, 10 microns to 50 microns, etc.

It will be appreciated that not all the channels need be coated with the one or more intermediate layers. For example, the intermediate layers can coat all of the inner channel surfaces of the inorganic porous support; or the intermediate layers can coat some of the inner channel surfaces of the inorganic porous support; and the phrase “the intermediate layer coats the inner channel surfaces of the inorganic porous support” is meant to encompass both situations.

As noted above, irrespective of whether or not the hybrid membrane structure includes the one or more porous intermediate layers, the hybrid membrane structure also includes an oxygen-ion conducting ceramic membrane. In those cases where the hybrid membrane structure does not include the one or more porous inorganic intermediate layers, the oxygen-ion conducting ceramic membrane coats the inner channel surfaces of the inorganic porous support. In those cases where the hybrid membrane structure does include the one or more porous inorganic intermediate layers, the oxygen-ion conducting ceramic membrane coats the surface of the one or more porous intermediate layers.

It will be appreciated that not all the channels need be coated with the oxygen-ion conducting ceramic membrane. For example, the oxygen-ion conducting ceramic membrane can coat all of the inner channel surfaces of the inorganic porous support; or the oxygen-ion conducting ceramic membrane can coat some of the inner channel surfaces of the inorganic porous support; and the phrase “the oxygen-ion conducting ceramic membrane coats the inner channel surfaces of the inorganic porous support” is meant to encompass both situations. Likewise, in those cases where the porous intermediate layer(s) is employed, the oxygen-ion conducting ceramic membrane can coat the surface of the one or more porous intermediate layers in every channel; or the oxygen-ion conducting ceramic membrane can coat the surface of the one or more porous intermediate layers in some of the channels; and the phrase “the oxygen-ion conducting ceramic membrane coats the surface of the one or more porous intermediate layers” is meant to encompass both situations.

In certain embodiments, the oxygen-ion conducting ceramic membrane has a thickness of from 5 nanometers to 0.5 millimeters, for example from 20 nanometers to 2 microns, for example from 20 nanometers to 1 micron, for example from 20 nanometers to 200 nanometers, for example from 20 nanometers to 50 nanometers. In other embodiments, the oxygen-ion conducting ceramic membrane has a thickness of from 20 nanometers to 50 nanometers. In certain embodiments, the thickness of the membrane is substantially uniform through each channel.

For certain applications, it may be desirable that the oxygen-ion conducting ceramic membrane coats the entire surface of the porous intermediate layer(s) or the entire inner channel surfaces of the inorganic porous support. As further illustration, for certain applications, it may be desirable that the number and/or size of any gaps, pinholes, or other breaks in the oxygen-ion conducting ceramic membrane coating be small in size and few in number (e.g., as in the case where there are no gaps, pinholes, or other breaks in the oxygen-ion conducting ceramic membrane coating or as in the case where the collective area of any gaps, pinholes, or other breaks in the oxygen-ion conducting ceramic membrane coating is less than 1% (such as less than 0.5%, 0.1%, 0.01%, etc.) of the total surface area coated by the oxygen-ion conducting ceramic membrane coating.

In some embodiments, the oxygen-ion conducting ceramic membrane is a pure ionic conducting membrane, such as one comprising doped zirconia or doped ceria. In other embodiments, the oxygen-ion conducting ceramic membrane is a mixed conductive membrane, such as one comprising SrCoO₃, SrFeO₃, La_{0.8}Sr_{0.2}FeO_{3-δ}, BaCe_{0.15}Fe_{0.05}O_{3-δ}, or a combination thereof. In some embodiments, the oxygen-ion conducting ceramic membrane comprises perovskites of rare earths like Sr, La, Ce, or Yb, in combination with group VIII elements like Fe and Co.

As mentioned above, it is desired in certain embodiments that at least some of the channels are plugged at one end of the support, for example on the inlet end of the support. In one embodiment of the invention, some of the channels are plugged at one end of the support, for example in a checkerboard pattern, and no channels on the other end of the support are plugged. In one aspect of this embodiment, channels not plugged on the inlet end include the oxygen-ion conducting membrane and the optional one or more intermediate layers. Additionally, channels that are plugged on the inlet end do not include any membrane or intermediate layer coatings. Thus, oxygen passing entering the inlet end of the support may permeate through the membrane and channel wall into an adjacent channel that is plugged on the inlet end. Oxygen-rich gas can then be collected from the outlet end of the channels plugged at the inlet. A gas collection system described below for use within a monolithic membrane structure may also be used in this embodiment of the invention as well.

Certain embodiments of the present invention can have advantages over conventional membranes, for example, in terms of durability and/or strength; in terms of regeneration or refurbishment; and/or in terms of permeation flux (for structures to be used in gas separation applications).

By way of illustration, in certain embodiments of the hybrid membrane structures of the present invention, the inorganic porous support structure can provide a backbone for surface area, mechanical strength, and durability, while providing surface area packing density comparable to the pure polymeric membranes.

Still additionally or alternatively, in certain embodiments of the hybrid membrane structures of the present invention, the inorganic porous support can have a substantially uniform pore structure on the inorganic porous support channel surfaces (or substantially uniform pore structure can be generated by the use of the optional one or more porous inorganic intermediate layers). This can enable deposition of a thin and durable oxygen-ion conducting ceramic membrane layer; and the thin oxygen-ion conducting ceramic membrane layer can offer high permeation flux. The hybrid membrane structures can thus provide a large potential advantage in manufacturing cost relative to the cost of manufacturing prior art inorganic membranes.

Monolithic oxygen-ion conducting ceramic membrane products of small channel sizes also offer surface area packing density nearly one order of magnitude higher than conventional tubular membrane of comparable body diameter. This can lead to dramatic reduction of both the membrane cost per surface area and the engineering costs to assembly large surface areas of membrane modules. Disk-shaped membrane products, on the other hand, are difficult for large-scale application.

Multiple-layered membrane structures enable the use of support structures of large pores (that is, high permeability through the bare support) and enable deposition of thin ion-conductive membrane layers (that is, high membrane permeation flux). As a result of enhancement to both support and membrane permeability, the present membrane-layer design enables achievement of high membrane permeation flux.

It will be appreciated that all, some, or none of the advantages discussed above may or may not be achieved in a particular hybrid membrane structure of the present invention. For example, a particular hybrid membrane structure of the present invention may be designed with other considerations in mind, and these other considerations may reduce or negate some or all of the above-discussed advantages or other advantages. The advantages discussed above are not meant to be limiting, and they are not to be construed, in any way, as limiting the scope of the invention.

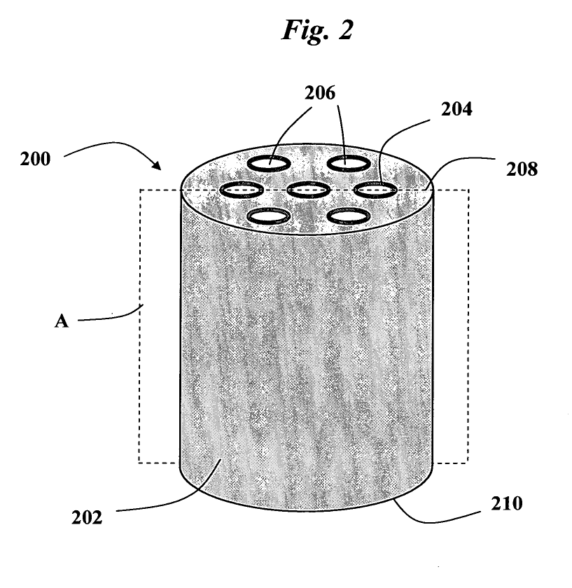

FIG. 2 is a perspective view of a hybrid membrane structure 200 according to one embodiment of the invention. In this embodiment, hybrid membrane structure 200 includes inorganic porous support 202 and oxygen-ion conducting ceramic membrane 204 either with or without one or more intermediate layers. Inorganic porous support 202 is shown as including first end 208, second end 210, and plurality of inner channels 206 that extend through inorganic porous support 202 from first end 208 to second end 210.

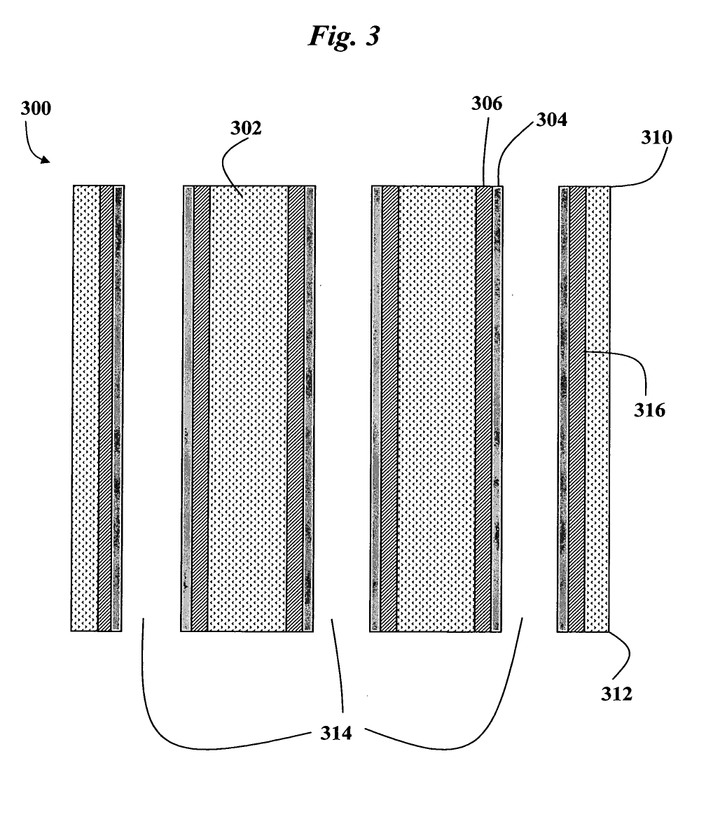

FIG. 3 is a longitudinal cross-sectional view of the hybrid membrane structure shown in FIG. 2 taken through plane A of FIG. 2. FIG. 3 illustrates an embodiment comprising one intermediate layer. In this embodiment, hybrid membrane structure 300 includes inorganic porous support 302, oxygen-ion conducting ceramic membrane 304, and a porous inorganic intermediate layer 306. Inorganic porous support 302 is shown as including first end 310, second end 312, and plurality of inner channels 314 that extend through inorganic porous support 302 from first end 310 to second end 312. Inner channels 314 of the support have surfaces 316 defined by porous walls, and first porous inorganic intermediate layer 306 coats surfaces 316 of inner channels 314. Oxygen-ion conducting ceramic membrane 304 coats the intermediate layer.

The hybrid membrane structures of the present invention can be prepared by a variety of procedures, such as, for example, by the methods discussed below.

The present invention also relates to a method for making a hybrid membrane structure. The method comprises:
providing a monolithic inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support; and
applying an oxygen-ion conducting ceramic membrane; wherein, when the one or more porous inorganic intermediate layers have not been applied to the inorganic porous support's inner channel surfaces, the oxygen-ion conducting ceramic membrane is applied to the inner channel surfaces of the inorganic porous support; and wherein, when the one or more porous inorganic intermediate layers have been applied to the inorganic porous support's inner channel surfaces, the oxygen-ion conducting ceramic membrane is applied to the surface of the one or more porous intermediate layers.

Suitable inorganic porous supports that can be used in the practice of the method of the present invention include those discussed hereinabove.

The inorganic porous support can be provided in a variety of different ways. For example, it can be obtained commercially. Alternatively, it can be prepared by methods that are well known to those skilled in the art.

Illustratively, suitable inorganic porous supports can be prepared in accordance with the methods described in co-pending U.S. Patent Application No. 60/874,070, filed Dec. 11, 2006, which is hereby incorporated by reference; in U.S. Pat. No. 3,885,977 to Lachman et al., which is hereby incorporated by reference; and in U.S. Pat. No. 3,790,654 to Bagley et al., which is hereby incorporated by reference.

For example, the inorganic porous support can be made by combining 60 wt % to 70 wt % of alpha-alumina (having a particle size in the range of 5 microns to 30 microns), 30 wt % of an organic pore former (having a particle size in the range of 7 microns to 45 microns), 10 wt % of a sintering aid, and other batch components (e.g., crosslinker, etc.). The combined ingredients are mixed and allowed to soak for a period of time (e.g., 8 to 16 hours). The mixture is then shaped into a green body by extrusion. The resulting green body is sintered (e.g., at a temperature of 1500° C. or greater for a suitable period of time, such as for 8 to 16 hours) to form an inorganic porous support.

As noted above, the method of the present invention can optionally include applying one or more porous inorganic intermediate layers to the inner channel surfaces of the inorganic porous support. Situations in which one might wish to use the optional porous inorganic intermediate layer(s) and suitable materials from which the porous inorganic intermediate layer(s) can be made include those that are discussed hereinabove.

In those situations in which the method of the present invention includes applying one or more porous inorganic intermediate layers to the inner channel surfaces of the inorganic porous support, the one or more porous inorganic intermediate layers can be applied to the inner channel surfaces using any suitable method. Illustratively, the porous inorganic intermediate layers can be applied by coating (e.g., flow coating in a suitable liquid) ceramic or other inorganic particles of appropriate size (e.g., on the order of tens of nanometers to a few micrometers) onto the inner channel surfaces of the inorganic porous support. The inorganic porous support coated with the ceramic or other inorganic particles is then dried and fired to sinter the ceramic or other inorganic particles, thus forming a porous inorganic intermediate layer. Additional porous inorganic intermediate layers can be applied to the coated inorganic porous support by repeating the above process (e.g., with different inorganic particles), typically with drying and firing after each layer's application.

The drying and firing schedules can be adjusted based on the materials used in the inorganic porous support and in the porous inorganic intermediate layer(s). For example, an alpha-alumina intermediate layer applied to an alpha-alumina porous support can be dried in a humidity controlled environment while maintaining a suitable temperature (e.g., 120° C.) for a suitable period of time (e.g., 5 hours); and, once dried, the alpha-alumina intermediate layer can be fired under conditions effective to remove organic components and to sinter the intermediate layer's alpha-alumina particles, such as, for example, at a temperature of from 900° C. to 1200° C. under a controlled gas environment.

Suitable methods for coating ceramic or other inorganic particles onto the inner channel surfaces of inorganic porous support and for forming them into porous inorganic intermediate layers are described, for example, in U.S. patent application Ser. No. 11/729,732, filed Mar. 29, 2007, which is hereby incorporated by reference; in U.S. patent application Ser. No. 11/880,066, filed Jul. 19, 2007, which is hereby incorporated by reference; and in U.S. patent application Ser. No. 11/880,073, filed Jul. 19, 2007, which is hereby incorporated by reference.

Irrespective of whether or not the method of the present invention includes the optional step of applying one or more porous inorganic intermediate layers to the inner channel surfaces of the inorganic porous support, the method also involves the application of an oxygen-ion conducting ceramic membrane. In those cases where one or more porous inorganic intermediate layers have not been applied to the inorganic porous support's inner channel surfaces, the oxygen-ion conducting ceramic membrane is applied to the inner channel surfaces of the inorganic porous support. In those cases where the one or more porous inorganic intermediate layers have been applied to the inorganic porous support's inner channel surfaces, the oxygen-ion conducting ceramic membrane is applied to the surface of the one or more porous intermediate layers.

Application of the oxygen-ion conducting ceramic membrane (i.e., to the inner channel surfaces of the inorganic porous support or to the surface of the one or more porous intermediate layers) can be carried out by any suitable process.

For example, the oxygen-ion conducting ceramic membrane can be applied onto the inner channel surfaces of the inorganic porous support or onto the surface of the one or more porous intermediate layers using a sol-gel method. In one embodiment, a sol precursor can be applied onto the inner channel surfaces of the inorganic porous support or onto the surface of the one or more porous intermediate layers, and the resulting structure can be dried and fired. The sol can be prepared, for example, by a modified Pechini method. Precursors used can include metal nitrates. Citric acid and ethylene glycol can be used as polymerization or complexation agents for the process. In this embodiment, a quantity of analytical reagent grade metal nitrates can be dissolved in D.I. water at 60° C. with stirring. After complete dissolution of the added nitrates, the specific quantities of citric acid and ethylene glycol can be added. The pH value of the solution can be adjusted to about 2 by adding concentrated nitric acid. After heating to about 85° C., a viscous perovskite polymeric sol can be formed with the removal of water and other volatile materials.

As another example, the oxygen-ion conducting ceramic membrane can be applied as a coating slip comprising particles of the oxygen-ion conducting ceramic, then dried and fired. The particles may be obtained, for example, by drying and firing the sole described above. As an additional option, the particles may be obtained through flame spray pyrolysis. The flame spray pyrolysis is a convenient method for making nano-sized particles of oxide solid solution material with large windows of the mixing ratios. When using this method for perovskite material preparation, the required amount of metal precursors can be first dissolved in a flammable solvent. The solution can then be pumped into a burner equipped with CH₄/O₂ and N₂ gas nozzles, as well as cooling water. The solution can be sprayed out with adjustable flames. The temperature of the central flame for burning the metal precursor may be set at 2000-3000° C., and can be adjusted by the burning gas composition and the solvent used. At this high temperature, the metal compounds will react with O₂ and form the oxide solid solution materials. The nanoparticle perovskites can then be collected, for example, with a quartz chamber. The advantages of using flame spray pyrolysis to make perovskite are: (1) this is a continuous process, and can make large scale production of powders; (2) nano-size perovskite powder can be obtained in one step.

In further embodiments, oxygen-ion conducting ceramic powder could also be made by other methods including solid solution reaction, hydrothermal synthesis, co-precipitation and calcination.

A flow-coating method can be used to uniformly coat the oxygen-ion conductive ceramic layer on the inner surface of monolith substrates (optionally with applied intermediate layers described herein). The method may be used to apply either a sol or slip described above. In this embodiment, the substrate is putting into a vacuum cell, with the outside surface wrapped with a Teflon tape. The polymeric sol or the slip of perovskite nanoparticles, for example, is then introduced into the inner channel of the monolith by pressure difference. The slips used for flow coating can have well-dispersed perovskite nanoparticles seeds in water at a concentration of 0.1˜10 wt. %. Binder polymers may be applied for the coating. After spinning, drying and firing, the resulted perovskite membrane layer can have a thickness of ˜0.5 μm, for example. The same coating-drying-calcination step can optionally be repeated one or more times to produce a helium gas-tight dense perovskite membrane.

In a further embodiment, the oxygen-ion conducting membrane can be applied by chemical vapor deposition (CVD). Suitable thicknesses, materials, and other suitable characteristics of the oxygen-ion conducting ceramic membrane are also discussed hereinabove and shall not be repeated here.

Hybrid membrane structures of the present invention and hybrid membrane structures made in accordance with the methods of the present invention can be used in a variety of applications, such as in methods for O₂ separation, including O₂ purification. For example, the invention includes a method for purifying O₂, which comprises:
introducing a feed gas stream comprising O₂ into the first end of a hybrid membrane structure according to claim 1; and

collecting a permeate gas stream from the hybrid membrane structure that is higher in O₂ content than the feed gas.

The feed gas in this embodiment may also comprise N₂, for example. In this context, the method of the invention could involve the separation of O₂ from N₂, with the retentate gas stream being higher in N₂ content than the feed gas.

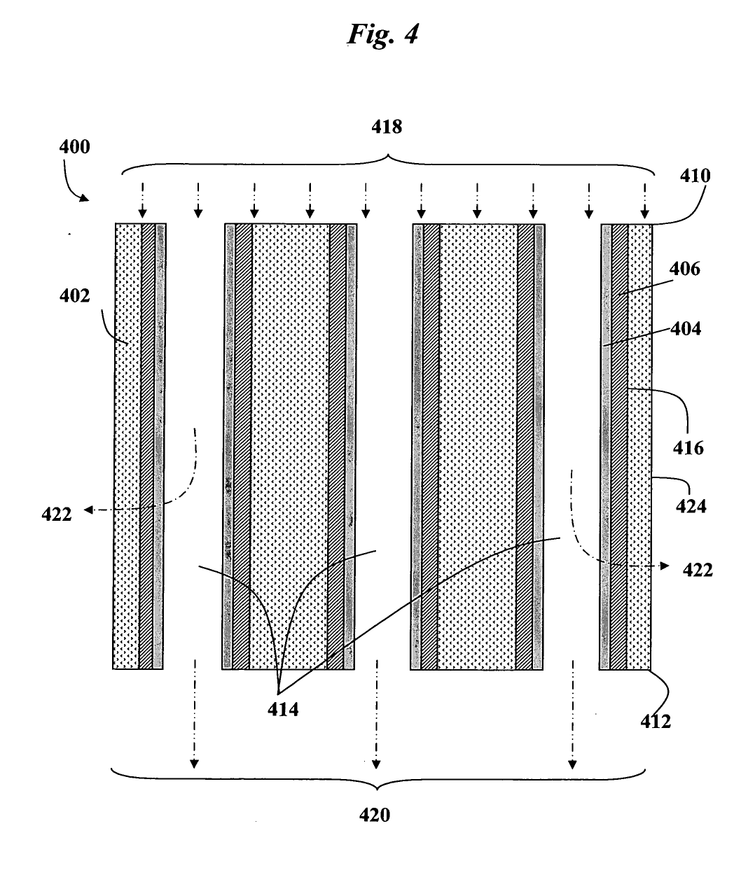

An example process is illustrated in FIG. 4. Feed gas 418 (in this instance comprising oxygen) is introduced into first end 410 of hybrid membrane structure 400 and passes into channels 414. Some of the oxygen molecules in feed gas 418 permeate through oxygen-ion conducting membrane 404 and intermediate layer 406 disposed on surface 416 of inorganic porous support 402, and, after passing through the pores of inorganic porous support 402, emanate from the hybrid membrane structure's outer surface 424. The path of such oxygen molecules is represented by arrows 422. The remainder of feed gas 418 remains in channels 414 and is permitted to exit second end 412 of hybrid membrane structure 400 as retentate gas stream 420. Retentate gas stream 420 that is collected from second end 412 of hybrid membrane structure 400 is lower in oxygen content than feed gas 418. Permeate gas 420 that is collected is higher in oxygen content than feed gas 418. Depending on the application and the nature of the feed gas involved, the collected gases can be stored, used as a feed gas in a further process, or discharged to the atmosphere.

It will be appreciated that a feed gas may comprise one or more other gases besides oxygen, such as carbon dioxide, water vapor, carbon monoxide, nitrogen, hydrocarbons, and combinations thereof, and that the invention may comprise separation of one or more of the components of the feed gas components. It will also be appreciated that the hybrid membrane structure of the invention may be used to separate one or more of such components from a feed gas stream, in addition to or as an alternative to separating oxygen.

To avoid gas molecules by-passing during gas separation process, the exposure surfaces of two ends of monolith porous membrane substrate could be coated with a gas-tight glass sealing layer. In this context, one end of the substrate could dipped into a ceramic glass paste and quickly blown through the channels with compressed air or N₂ to prevent blockage by the paste. The glass paste can cover the cross-sectional surface and exterior surface (0.5-1 cm long from the end) of the end part. Then, the other end can be coated by the same way. After drying at ambient condition for 1-2 h, for example, the coated substrate can be heated in air up to 1000-1400° C. with a heating rate of 120-150° C./min based on different glass compositions. The substrate can be maintained at 1000-1400° C. for 40-60 min, and then cooled down to room temperature at a ramp rate of 120-150° C./min. One more glass coating may also be advisable for achieving a gas-tight seal.

As mentioned earlier, the monolithic inorganic porous support of the embodiments described above may itself comprise an oxygen-ion conducting ceramic material. Thus, in a separate embodiment now described, the present invention includes a monolithic inorganic porous membrane comprising a first end, a second end, and a plurality of inner channels having surfaces defined by porous walls and extending through the support from the first end to the second end, wherein the monolithic inorganic porous membrane comprises a mixed-conductive material, such as SrCoO₃, SrFeO₃, La_{0.8}Sr_{0.2}FeO_{3-δ}, BaCe_{0.15}Fe_{0.05}O_{3-δ}, or a combination thereof. This membrane itself has utility in gas separation applications, such as oxygen separation.

The structural characteristics of the monolithic membrane, such as the number of inner channels, median pore size on the inner channel surfaces, porosity, and configuration and size of inner channels, are as described for the monolithic inorganic porous support described earlier and will not be repeated here. For instance, exemplary shapes of the inner channels include round, square, hexagonal, and triangle shapes. Wall thickness within a honeycomb may be, for example, from 0.025 millimeters to 2 millimeters, for instance 0.05 millimeters to 1 millimeter. The inner channels may have a hydraulic diameter of, for example, from 0.5 millimeters to 7 millimeters, for instance 0.7 millimeters to 2 millimeters. The monolithic membrane can be prepared, for example, by directly extruding mixed-conductive-membrane precursor through a die and then firing the green parts at a high temperature (for instance from 1000° C. to 1500° C.) to form a dense membrane honeycomb.

In one embodiment of the monolithic membrane, a portion of the inner channels of the first end of the structure are plugged, while all other channels on the first end and second end are not plugged. In certain embodiments, it is desired that the plugged and unplugged channels on the first end form a checkerboard pattern with each other. FIG. 7 is a representation of a honeycomb membrane 700 comprising plugged channels 702 (shaded in gray) in a checkerboard pattern with unplugged channels 704 (no shading) on the first end 706 of the honeycomb. In this embodiment, all channels on the second end 708 are not plugged.

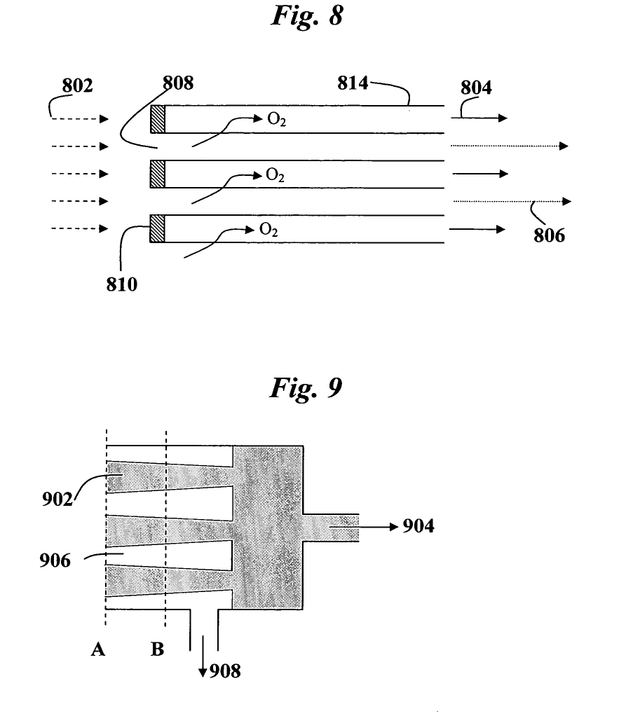

The plugging of a portion of the channels on the first end of the membrane structure described above allows for certain gas separation applications. For instance, as a gas comprising oxygen flows through the open channels on the first end of the membrane structure, at least a portion of the oxygen in the gas stream permeates the mixed conductive membrane into adjacent channels under the oxygen partial pressure difference. Those adjacent channels, plugged at the first end of the membrane structure, therefore become high in oxygen concentration. FIG. 8 illustrates this separation within a portion of a honeycomb membrane structure. Gas stream 802 enters unplugged channels 808 at the first end of the honeycomb, and oxygen permeates the channel walls 814 into channels 810 that are plugged at the first end. Gas stream 804 exiting the second end of the plugged channels is then higher in oxygen content than the oxygen-depleted gas stream 806.

A gas collection system may be used to collect gas streams exiting the second end of the honeycomb structure in the oxygen-rich channels separately from gas streams exiting the second end of the honeycomb structure in the oxygen-depleted channels. For example, a collection system can include an interface that matches the channels of the membrane structure. A tubing system, such as round or square tubes, may be used to collect the oxygen-depleted gas streams, for instance. The oxygen-rich streams can merge outside of the tubing and be collected from a gas outlet.

FIG. 9 illustrates an example gas collection system. At cross-section A, tubing 902 is aligned with channels at the end of the membrane structure carrying oxygen-depleted gas. The tapered shape of the tubing allows for merging gas from oxygen-rich channels into one space 906 for oxygen collection, and enhances oxygen partial pressure difference by reducing oxygen-depleted flow space and increasing oxygen-rich flow space. Oxygen-depleted gas 904 collected from the tubing exits the gas collection system at one port, while oxygen-rich gas 908 not captured by the tubing exits the gas collection system at another port.

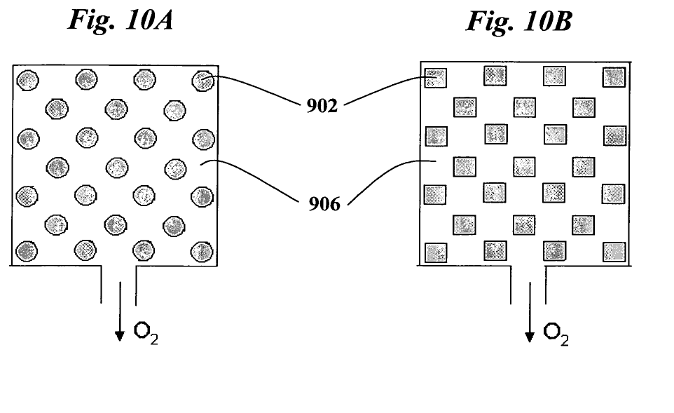

FIGS. 10A and 10B illustrate two embodiments of the shape of the tubing in the gas collection system as seen through cross-section B of FIG. 9. FIG. 10A illustrates a round shape of the gas tubing, and FIG. 10B illustrates a square shape of the gas tubing. For ease of illustration, channels not connected to tubing are not shown.

The present invention is further illustrated by the following non-limiting examples.

### Example 1

### Monolith Porous Alumina Supports with Intermediate Layers

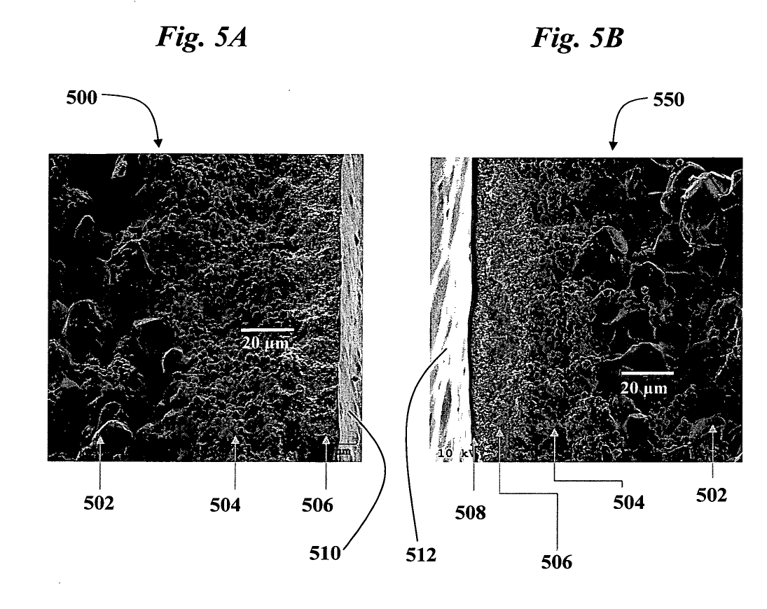

This example describes two supports, with applied intermediate layers, suitable for use in embodiments of the present invention. FIGS. 5A and 5B are SEM images of the cross-sections of the supports having two intermediate layers 500 and three intermediate layers 550.

The supports have an outer diameter ranging from 8.7-10.0 mm and a length of 80-150 mm, comprising 19 channels of average diameter of 0.75 mm uniformly distributed over the cross-sectional area. The supports 502 are made of alpha-alumina, with an alpha-alumina precoat 504 and additional alpha-alumina layer 506 with a median pore size of 100-200 nm. FIG. 5B illustrates a further gamma-alumina top layer 508 with a pore size of around 5 nm. The SEM images also illustrate the exposed surfaces 510 and 512 of the alpha alumina layer and gamma-alumina layer of FIGS. 5A and 5B, respectively. An oxygen-ion conducting ceramic membrane may then be applied to those surfaces.

### Example 2

### Preparation of LSF Polymeric Sol

This example describes the preparation of an LSF (La_{0.8}Sr_{0.2}FeO_{3-δ}) polymeric sol by a modified Pechini process. Precursors used for LSF were the analytically pure (99.9%, Alfa Aesar) metal nitrates. Citric acid and ethylene glycol were used as polymerization or complexation agents for the process. 150 ml D.I. water was heated up to 60° C. Then 34.64 g of La(NO₃)₃.6H₂O, 2.48 g of Sr(NO₃)₂, and 40.4 g of Fe(NO₃)₃.9H₂O were dissolved in the hot D.I. water with stirring. After complete dissolution of the added salts, 115.27 citric acid (Alfa Aesar) and 55.84 g of ethylene glycol (Fisher) were added. The mixture was heated up to 85° C. to remove the water and other volatile matter, until it turned to a viscous liquid.

### Example 3

### Preparation of BaCe_{0.15}Fe_{0.05}O_{3-δ} Perovskite Powder by Flame Spray Pyrolysis

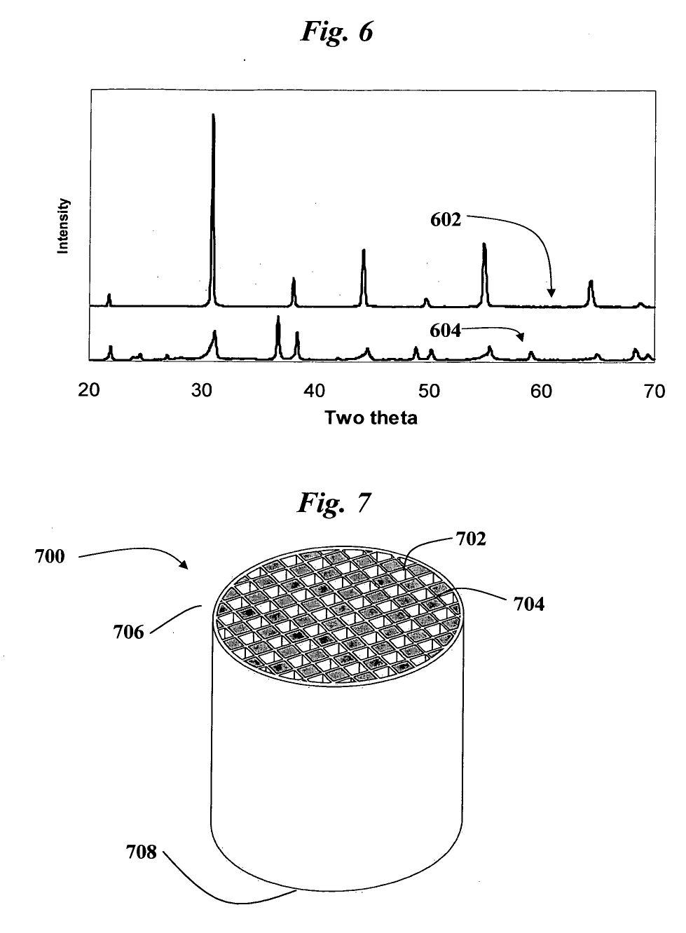

BaCe_{0.15}Fe_{0.05}O_{3-δ} perovskite has very high chemical stability. Flame spray pyrolysis has been proven to be used in making this material. 65.3 g of Ba(NO₃)₂, 16.3 g of Ce(NO₃)₃.6H₂O and 85.8 g of Fe(NO₃)₃.9H₂O were dissolved in 8L of 1:1 volume ratio of H2O/EtOH, and obtained clear solution. This solution underwent a flame spray pyrolysis process to obtain a red-brown color powder. FIG. 6 shows the XRD of this as prepared powder 604. The obtained powder still contains nitrate compound. FIG. 6 also shows the XRD pattern of the powder heated (calcined) to 1200° C. 602. It shows a well crystallized single phase perovskite structure. This perovskite powder can be coated onto a passivated honeycomb channel wall for forming an O₂ permeable membrane.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention, as defined in the claims which follow.

1. A hybrid membrane structure comprising:
a monolithic inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
an oxygen-ion conducting ceramic membrane; wherein, when the hybrid membrane structure does not comprise the one or more porous inorganic intermediate layers, the oxygen-ion conducting ceramic membrane coats the inner channel surfaces of the inorganic porous support; and wherein, when the hybrid membrane structure comprises the one or more porous inorganic intermediate layers, the oxygen-ion conducting ceramic membrane coats the surface of the one or more porous intermediate layers.

2. A hybrid membrane structure according to claim 1, wherein the inorganic porous support is a honeycomb monolith.

3. A hybrid membrane structure according to claim 1, wherein the inorganic porous support is a ceramic monolith.

4. A hybrid membrane structure according to claim 1, wherein the inorganic porous support comprises cordierite, alpha-alumina, delta-alumina, gamma-alumina, carbon, mullite, aluminum titanate, titania, zirconia, zeolite, metal, silicon carbide, silicon nitride, ceria, or combinations thereof.

5. A hybrid membrane structure according to claim 1, wherein the inner channels of the inorganic porous support have a hydraulic inside diameter of 3 millimeters or less.

6. A hybrid membrane structure according to claim 1, wherein the inorganic porous support has a porosity of from 35 percent to 50 percent.

7. A hybrid membrane structure according to claim 1, wherein the hybrid membrane structure does not comprise the one or more porous inorganic intermediate layers, wherein the inner channel surfaces of the inorganic porous support comprise a median pore size of 1 micron or less, and wherein the oxygen-ion conducting ceramic membrane coats the inner channel surfaces of the inorganic porous support.

8. A hybrid membrane structure according to claim 1, wherein the hybrid membrane structure comprises the one or more porous inorganic intermediate layers and wherein the oxygen-ion conducting ceramic membrane coats the surface of the one or more porous intermediate layers.

9. A hybrid membrane structure according to claim 8, wherein the porous walls of the inorganic porous support comprise a median pore size of from 5 microns to 15 microns.

10. A hybrid membrane structure according to claim 8, wherein the one or more porous intermediate layers comprise alpha-alumina, delta-alumina, gamma-alumina, titania, zirconia, silica, cordierite, mullite, aluminum titanate, zeolite, metal, ceria, or combinations thereof.

11. A hybrid membrane structure according to claim 8, wherein at least one intermediate layer comprises a median pore size of from 20 nanometers to 1 micron.

12. A hybrid membrane structure according to claim 11, wherein at least one intermediate layer comprises silica, zirconia, or a combination thereof.

13. A hybrid membrane structure according to claim 1, wherein the hybrid membrane structure comprises at least two intermediate layers.

14. A hybrid membrane structure according to claim 13, wherein the first intermediate layer closest to the inorganic porous support comprises a median pore size of from 20 nanometers to 1 micron and the intermediate layer closest to the oxygen-ion conducting ceramic membrane comprises a median pore size of 10 nanometers or less.

15. A hybrid membrane structure according to claim 8, wherein the one or more porous intermediate layers have a combined thickness of from 20 nanometers to 100 microns.

16. A hybrid membrane structure according to claim 1, wherein the oxygen-ion conducting ceramic membrane has a thickness of from 5 nanometers to 0.5 millimeters.

17. A hybrid membrane structure according to claim 1, wherein the oxygen-ion conducting ceramic membrane is a pure ionic conducting membrane.

18. A hybrid membrane structure according to claim 17, wherein the oxygen-ion conducting ceramic membrane comprises doped zirconia, doped ceria, or a combination thereof.

19. A hybrid membrane structure according to claim 1, wherein the oxygen-ion conducting ceramic membrane is a mixed conductive membrane.

20. A hybrid membrane structure according to claim 19, wherein the oxygen-ion conducting ceramic membrane comprises SrCoO₃, SrFeO₃, La_{0.8}Sr_{0.2}FeO_{3-δ}, BaCe_{0.15}Fe_{0.05}O_{3-δ}, or a combination thereof.

21. A method for separating O₂ from a gas stream, said method comprising:
introducing a feed gas stream comprising O₂ into the first end of a hybrid membrane structure according to claim 1; and
collecting a permeate gas stream from the hybrid membrane structure that is higher in O₂ content than the feed gas.

22-26. (canceled)

27. A monolithic inorganic porous membrane comprising a first end, a second end, and a plurality of inner channels having surfaces defined by porous walls and extending through the support from the first end to the second end, wherein the monolithic inorganic porous membrane comprises a mixed-conductive material.

28. A monolithic inorganic porous membrane according to claim 27, which comprises SrCoO₃, SrFeO₃, La_{0.8}Sr_{0.2}FeO_{3-δ}, BaCe_{0.15}Fe_{0.05}O_{3-δ}, or a combination thereof.

29. A monolithic inorganic porous membrane according to claim 27, wherein a portion of the channels are plugged at the first end, wherein the same channels are not plugged at the second end.

30. A method for separating O₂ from a gas stream, said method comprising:
introducing a feed gas stream comprising O₂ into the first end of a monolithic inorganic porous membrane according to claim 29; and
collecting at the second end of the monolithic inorganic porous membrane an oxygen-rich gas stream from the channels plugged at the first end.
